(19) United States
(12) Patent Application Publication
(10) Pub. No.: US 2002/0133523 A1
(43) Pub. Date: Sep. 19, 2002

(54) Multilingual graphic user interface system and method

(76) Inventors: Anthony Ambler, Horseheads, NY (US); Juan E. Flores, Owasso, OK (US); William Wheeler, Sand Springs, OK (US)

Correspondence Address: McGuireWoods, LLP, Suite 1800, 1750 Tysons Blvd., McLean, VA, 22102, US

(21) Appl. No.: 09/907,610

(22) Filed: Jul. 19, 2001

Related U.S. Application Data
(60) Provisional application No. 60/276,846, filed on Mar. 16, 2001.

(51) Int. Cl. G06F 15/00

(52) U.S. Cl. 707/536

(57) ABSTRACT

A multilingual user interface system and method that allows for easily and immediately switching between available languages, without interrupting application program operation, and easily adding and editing a wide array of languages and language-specific user interface attributes, without modifying the application program and without requiring significant, if any, programming skills, is described. A table of user interface attributes confers language specificity.

### CO-PENDING APPLICATION

This application claims priority to U.S. Provisional Application 60/276,846, filed Mar. 16, 2001, the entire contents of which are hereby incorporated by reference herein.

### FIELD OF THE INVENTION

This invention relates to the field of user interfaces. More specifically, the present invention relates to a multilingual user interface that can be easily configured and updated.

### BACKGROUND

User interfaces provide a repertoire of controls and messages to facilitate communication and the performance of tasks. Messages may include various means for communicating, such as icons, text and synthesized speech. A control may be a custom-designed object or any of the standard (and similarly constructed) graphic user interface (GUI) software library objects, such as text boxes, buttons, radial buttons, pull-down lists, or menu bar items. A typical user interface screen displays a variety of such messages and controls, arranged in a particular manner and customized to reflect application-specific requirements. By activating controls, users can rapidly carry out tasks without having to learn, remember or enter keyboard commands.

In today's global marketplace, it is increasingly likely that computer-controlled machines will be sold in many different countries and accessed by users of various nationalities. To facilitate use, user interface controls and messages should be presented in either a universally recognizable iconic form or have explanatory text in the dominant language of the country of use, at least in the form of so-called “bubble help” messages. However, unambiguous and informative icons are rare and restricted in usefulness to only simple, universal and culturally-neutral concepts.

Computer-controlled machines present special user interface design challenges, as they often require a wide array of unique controls and messages to perform necessary machine-specific functions and communicate machine-specific information. Because universally recognizable iconic forms may not exist for many such functions, most machine-control GUI objects require textual control explanations to ensure user understanding, for example, in the form of “bubble-help” messages.

Similarities between controls further necessitate clear, precise explanatory text. User interfaces may include a vast array of controls, many of which may perform closely similar functions. Without explanatory text, a user may be unable to distinguish the function of one control from another.

In some cases, workers' safety demands clearly communicative controls in an operator's native language. Misinterpretation of controls can lead to misuse of a computer-controlled machine, possibly endangering the operator and co-workers.

Workplace diversity compounds the GUI design challenges for computer-controlled machines. Groups of diverse users may access a specific computer-controlled machine. Within a single country, a machine operator may prefer or require textual control explanations in a language other than the country's dominant language. In the United States, for example, a person having minimal American English skills but fluent in another language (e.g., Spanish, Vietnamese, Russian, etc.) may operate a computer-controlled machine, such as a mail sorter or CNC manufacturing machine. Even within a facility, individuals having diverse language skills may access the same computer-controlled machine. For example, an American English speaking supervisor may oversee several operators, one of whom is fluent in Spanish and another in Vietnamese, while a technician speaks primarily Russian.

Nuances of meaning between different dialects of apparently the same language further complicate optimal machine-to-man communications. What may be an optimal presentation of an English-language GUI control displayed to an operator in London, Ky., U.S.A. , may be quite different than the same displayed to an operator in London, England, UK.

Interface design and modification processes can be laborious and expensive. Software engineers often design controls for a specific GUI. In a well-designed GUI, the controls should comport with user intuition. A goal is to build on the knowledge and skills users have acquired through experience (e.g., pointing, moving, toggling, sliding, etc.) and exploit these to facilitate communication with a computer. When marketing or customer feedback indicates that GUI controls are unclear, confusing or counter-intuitive, costly and time-consuming software modifications may be required. These modifications are typically reserved for the software professional having access to the necessary source code and tools, such as a compiler. Implementing modifications may entail design, coding, compilation and testing, and often leads to errors. Users lacking either the necessary technical skills or access to the source code and tools are unable to make even the simplest control modification, contributing to user frustration.

To accommodate a foreign user's preferences, a vendor may customize the application program. However, such customization is costly, time consuming and conducive to error. Additionally, customization typically provides a single foreign language solution, thus failing to address the needs of individuals that speak different foreign languages within a facility (e.g., Spanish speaking operators in a French facility).

Another approach has been to merge a translator with an application program. The translator converts primary language control text to the user's desired language. While translation may help bridge the gap for foreign speaking users, this approach is not without serious drawbacks. Particularly, such methods may require modification of the program code to accommodate the translator, again a costly and time-consuming task. Additionally, translation compromises program efficiency, as it introduces several intervening steps (e.g., message interception, database lookup, etc.) into the recurring GUI display process. Such translators are also typically limited to converting character-based textual information, while ignoring font parameters, icons and graphic form text incorporated into many controls. Furthermore, translators are typically relegated to literal translations, which are often not the most efficacious way to express a concept in a foreign language. For example, translators do not accommodate differences in function that may be more intuitive in one language than another. Moreover, initiating a translated language generally entails restarting the application, which causes delay and presents difficulty, if not impossibility, of retaining data.

Some multilingual systems require a restart. To the extent switching the language entails restarting the application, a time consuming process, and possibly losing data, such systems effectively preclude leveraging the user interface as a translator. Preferably, a user interface should facilitate communication between users that speak different languages. For example, an American English speaking instructor or supervisor and a Spanish speaking trainee should be able to conveniently use the interface as a translator by flip-flopping between their respective languages. Thus, the instructor or supervisor would easily be able to determine the Spanish equivalent for a control function and communicate that term to the trainee.

In sum, current multilingual user interface systems and methods do not facilitate easy and immediate switching between available languages, without interrupting application program operation and without requiring intervening translation steps to update a displayed user interface according to a selected language. Current systems also fail to enable easily adding and editing a wide array of languages and language-specific user interface attributes, without modifying the application program and without requiring significant, if any, programming skills.

### SUMMARY

It is therefore an object of the present invention to provide a multilingual user interface that accommodates a wide array of foreign languages.

Another object of the present invention is to provide a multilingual user interface that allows users to easily and immediately switch between available languages.

Another object of the present invention is to provide a multilingual user interface that allows languages to be switched without interrupting application program operation.

Another object of the present invention is to provide a multilingual user interface that facilitates use of the interface as a translator between users speaking different languages.

Another object of the present invention is to provide a multilingual user interface that allows switching between available languages without introducing intervening translation steps to update a displayed user interface according to a selected language.

Another object of the present invention is to provide a structured framework that facilitates adding a wide array of languages, including languages that do not adhere to the Latin alphabet (i.e., the alphabet included in the ASCII character code set), without modifying the application program and without requiring significant, if any, programming skills.

Another object of the present invention is to provide a structured framework that facilitates editing language-specific user interface attributes, without modifying the application program and without requiring significant, if any, programming skills.

Still another object of the invention is to provide means to adjust interface text attributes, enabling the interface text to fit within available space for the corresponding control.

Yet another object of the invention is to provide means for specifying non-literal foreign-equivalent interface text such as an acronym, an abbreviation, or a non-literal translation of the interface text to succinctly convey the same meaning to a user.

An additional object of the invention is to provide means for easily adding audio data files corresponding to audio output, such as spoken messages, in a selected language.

To accomplish these and other objects of the invention, a system and method are provided that allow users to easily and immediately switch between available languages, without interrupting application program operation and without requiring intervening translation steps to update a displayed user interface according to a selected language. The system and method of the present invention also facilitates adding and editing a wide array of languages and language-specific user interface attributes, without modifying the application program and without requiring significant, if any, programming skills.

### BRIEF DESCRIPTION OF THE DRAWINGS

The foregoing and other objects, features and advantages of the present invention will become better understood with reference to the following description, appended claims, and accompanying drawings, where:

FIG. 1 is a schematic diagram of an exemplary computer system for implementing a preferred embodiment of the present invention;

FIG. 2 depicts an exemplary user interface with an array of language controls, particularly flag icons, corresponding to available languages, in accordance with the present invention;

FIG. 3 depicts a preferred language resource control file structure for defining interface language-specific attributes in accordance with the present invention;

FIG. 4 shows a preferred data record format for specifying language-specific control attributes in accordance with the present invention;

FIG. 5 shows a flowchart of a preferred language update process in accordance with the present invention; and

FIG. 6 depicts an exemplary user interface with an array of language controls, including flag icons and icons reserved for languages to possibly be added, in accordance with the present invention.

### DETAILED DESCRIPTION

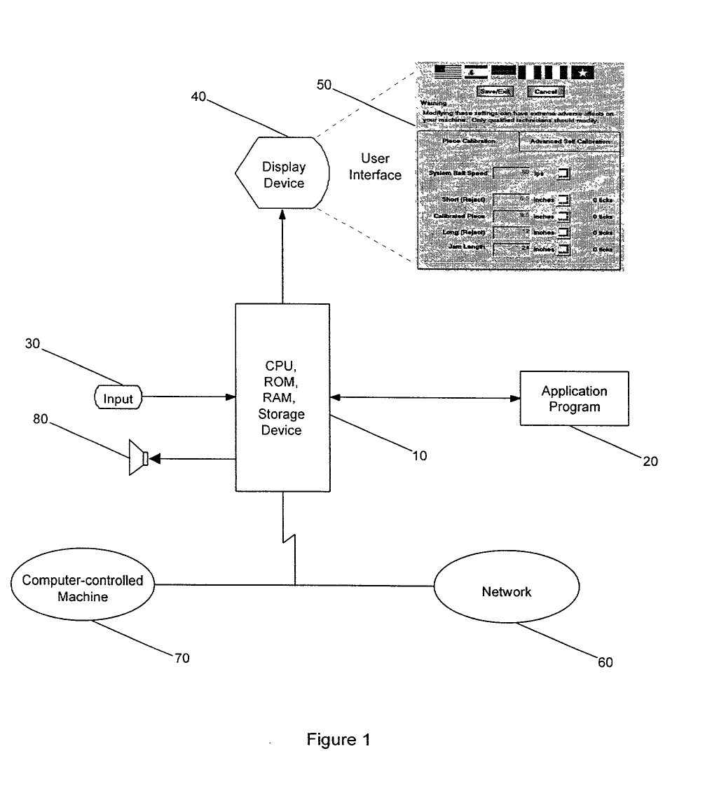

Referring to FIG. 1, a computer system in which the present invention may preferably be implemented generally includes a central processing unit, a non-volatile read only memory (ROM), a volatile random access memory (RAM), and a storage device 10, along with one or more input means for receiving user input 30 and a display 40. The input means 30 may include a mouse, joystick, keyboard, touch or light activated display screen, or any device that enables user selection of a user interface control. Optionally, the system may also include an audio output controller connected to one or more speakers 80. The system may either stand alone or connect to other devices such as a computer network 60 and/or, in a preferred implementation, a computer-controlled machine 70.

In an exemplary environment implementing the present invention, an application program 20 runs on the computer system. A user interface 50 (referred to herein as a user interface or GUI) appears on the display device 40 and presents a user with messages and visual interface controls. The controls, which may include graphic images as well as textual information, respond to user interactions via the input means 30, invoking predefined functions within the application program 20.

A preferred implementation of the present invention generally includes (i) interface controls for selecting a specific language, such as the language specific controls discussed more fully herein, (ii) a reference source including data corresponding to language-specific interface attributes for a selected language, such as the table referred to as the Language Resource Control File (LRCF) and described more fully herein, and (iii) means for automatically updating such attributes to comport with a selected language by defining language-specific user interface attributes with data from the reference source. The user interface includes the controls for selecting a specific language. User selection of a language-specific control triggers an update process, obtaining corresponding language-specific data from the table and updating the user interface accordingly.

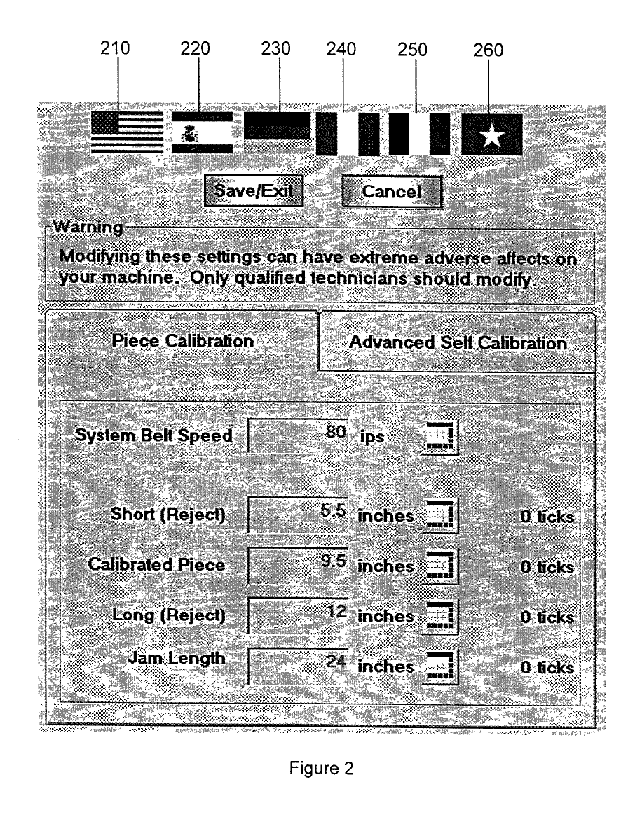

Referring now to FIG. 2, there is shown an otherwise conventional user interface, with an added array of language specific controls, particularly U.S. 210, Spanish 220, German 230, Italian 240, French 250 and Vietnamese 260 flag icons, corresponding to available languages. Though FIG. 2 shows flags, any language-specific icons may be used. For example, standard country abbreviations (e.g., U.S., DE or UK), country images (e.g., the distinctive boot-shaped contour of Italy), text, or other language-specific identifiers can be employed. The language choices may also be presented in a drop down menu, on a separate screen, in a separate window, or with other user interface controls. Additionally, while FIG. 2 shows controls for six languages, any number of language-specific icons may be used; though a small number should typically suffice, particularly if user-responsive substitution is provided as is preferred.

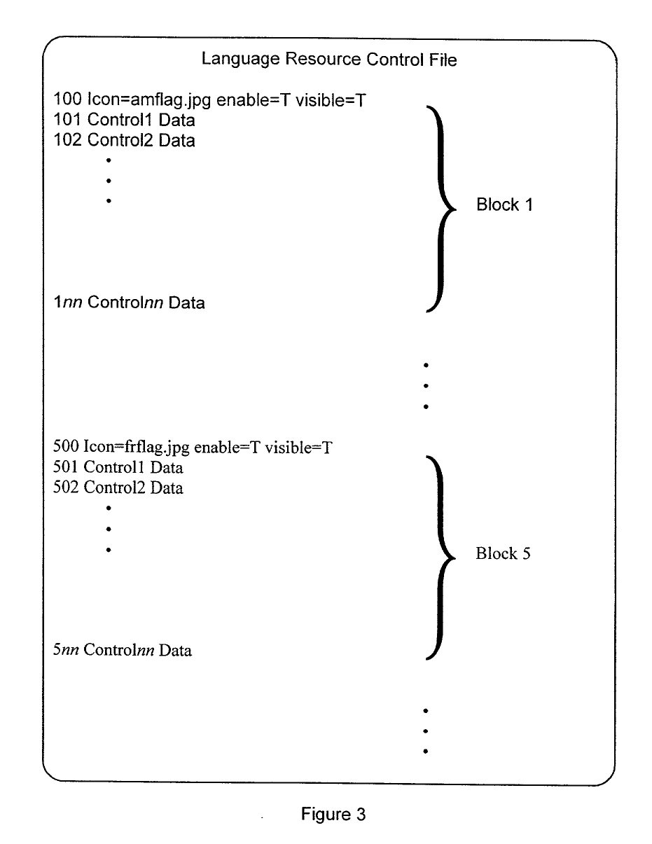

FIG. 3 shows a diagram representative of an exemplary LRCF structure, consistent with the present invention. The LRCF, which may be in the form of an initialization (.INI) file structure, includes language-specific information. As a reference source, the LRCF may take a form other than an initialization (.INI) file structure, such as a database, table, or the like. Preferably, the form chosen for the LRCF is conducive to modification of the language-specific information by a non-programmer with relative ease. As shown, the LRCF arranges the information in a table format comprised of blocks of data, one block for each available language. Each block includes a data record for each language-specific interface control, with each such record including data elements corresponding to language-specific attributes of the specific control.

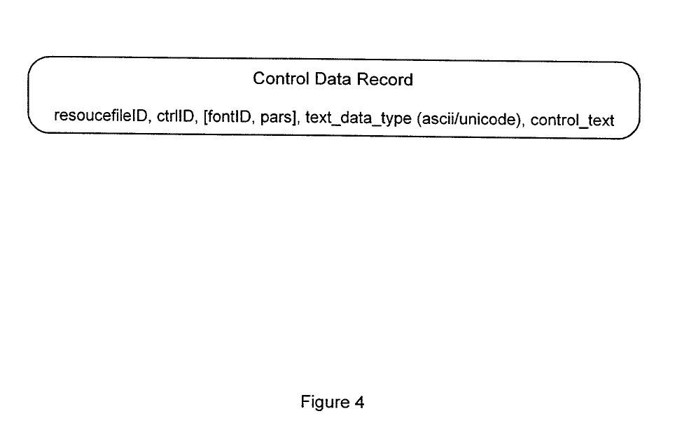

Preferably, the language-specific attributes for a control or message include text, if any, for the control or message in a selected language, though other data may also be included. An exemplary control-specific data record format, as shown in FIG. 4, includes a line number (resourcefileID), a control identifier (ctrilID), a font identifier (fontID), font parameters (pars), a text data type reference (text_data_type), and the characters specific to a given control or message as represented in a selected language (control_text). The record format may further include data elements corresponding to other language-specific interface attributes, such as references to a graphic image file for an icon and an audio data file corresponding to a spoken message in the selected language. Alternatively, the system can be configured to automatically retrieve any such graphic images and audio data files from certain locations (e.g., certain file directories) using a file naming convention.

In the example shown in FIG. 3, the first (leftmost) digit of the three-digit line number (resourcefileID) corresponds to an LRCF block. The remaining two digits correspond to line numbers within the block, starting with line 00. Each available language icon 10-60, as shown in FIG. 2, is associated with a unique LRCF offset value, which identifies the first line of the block corresponding to a selected language. For example, the LRCF shown in FIG. 3 associates American English control data with LRCF offset value 100, comprised of the block number 1 and first line number 00 for that block. This means that lines 100 to 1nn include data corresponding to the American English language for each of the nn interface controls. Specifically, line 100 includes data pertaining to the American English language control, in this case an American flag icon 210. Similarly, lines 101 through 1nn include American English language data pertaining to interface Control1 through Controlnn, respectively.

To further illustrate, the LRCF shown in FIG. 3 associates French control data with LRCF offset value 500, meaning that lines 500 to 5nn include data corresponding to the French language for each of the nn GUI controls. Specifically, line 500 includes data pertaining to the French language control, in this case the French flag icon 250 as shown in FIG. 2. Similarly, lines 501 through 5nn include French language data pertaining to interface Control1 through Controlnn, respectively.

Each control identifier (ctrlID) corresponds to a specific user interface control or message. Thus, for example, line number 101 includes American English language data for Control1. Similarly, line number 501 includes French language data for the same Control1.

In a preferred implementation, data records include data elements corresponding to font attributes for a particular control or message, such as the font identifier (fontID) and font parameters (pars) as shown in FIG. 4. The font identifier defines the typeface for displaying the corresponding text, i.e., the particular styled appearance (e.g., Times Roman, Helvetica, Arial, etc.) regardless of size or other attributes. Font parameters (pars) define the size and other attributes of the corresponding text, such as 12-point, italic and bold. Specification of such parameters is an important feature of the preferred implementation, as it confers an ability to “force fit” lengthy control text into available space for the corresponding control. To illustrate, the Italian translation of the American English control text “conveyor speed” is “velocità del trasportatore,” which contains an additional space as well as eleven more alphanumeric characters than its American English counterpart. The subject invention allows the font parameters to be adjusted (e.g., by reducing type size, or by displaying normal instead of bold text) to ensure that the desired text fits within the available space for the control.

Specification of the text data type reference (text_data_type) is another important feature of a preferred implementation of the subject invention, as it confers an ability to properly and efficiently display a wide array of language text. The text data type reference (text_data_type) defines the applicable character code set, e.g., 8-bit ASCII (ISO 8859) or 16-bit Unicode (ISO 10646). Since 8-bit ASCII is capable of encoding only 256 characters, it is unsuitable for the large number of characters and symbols needed for many languages that do not adhere to the Latin alphabet (i.e., the alphabet included in the ASCII character code set). Unicode, a 16-bit code capable of representing 65,536 characters, assigns blocks to various languages and special character groups covering many of the principal written languages of the Americas, Europe, the Middle East, Africa, India, Asia and the Pacific. Nevertheless, where the standard Latin alphabet will suffice, the text data type is preferably set to ASCII. This allows efficient use of resources, because of the size of files coded using 8-bit ASCII code versus 16-bit Unicode. In an alternative embodiment, a single text data type may apply to all language-specific attributes of a given interface system. In such a case, it would not be necessary to specify the text data type for each particular control or message.

Data records also include data elements corresponding to the text for a particular control or message (control_text) in a specific language. Specifying interface text for each language, provides needed flexibility for customization, as a direct literal translation is often not the most efficacious foreign equivalent. For example, rather than adhere to a wordy literal translation of American English text, the LRCF allows a foreign abbreviation, acronym, non-literal translation or some other foreign equivalent to succinctly convey the same meaning to the user. Furthermore, by providing character-based text, the control or message can be updated at the time of on-screen rendering, thereby facilitating dynamic modification.

Data records may further include a data element identifying a digital audio data file (control_speech) for certain controls and messages. Alternatively, the system may be configured to automatically retrieve any such audio data files for a control or message from a certain location (e.g., file directory c:\GUI\Speech) based on a file naming convention (e.g., 101.wav). Thus, for example, upon detection of a malfunction of a computer-controlled machine, an operator may be notified with an error message displayed in text format and an audio file for the spoken message played in the operator's selected language.

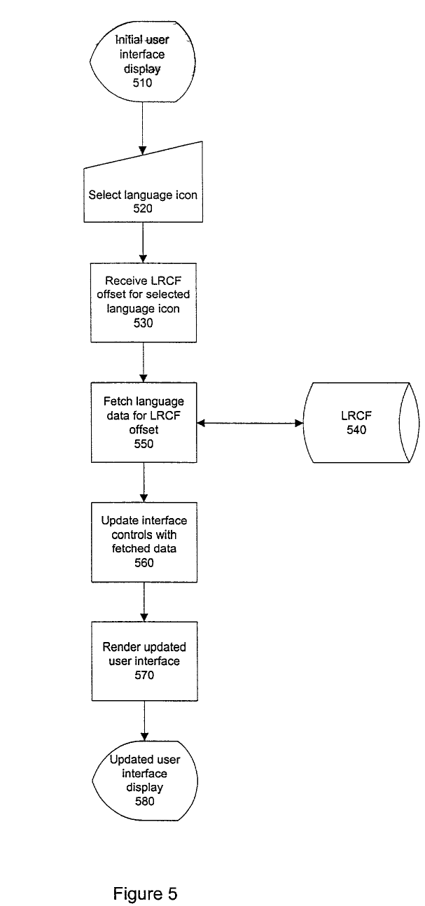

Software for rendering a user interface in accordance with the present invention preferably accepts language-specific interface data as values to variables. The values may be derived from a table or array, such as the LRCF, based on a reference offset, such as the LRCF offset value. For example, using the LRCF conventions described above for FIG. 3, the control text for Control8 equals the control text (control_text) specified in line x+08, where x is the LRCF offset value. Thus, upon selection of the French flag icon, corresponding to LRCF offset value 500, the control text for Control8 equals the control text (control_text) specified in line 508 of the LRCF. The software also preferably refreshes or redraws the entire displayed user interface, or at least all affected interface controls being displayed, upon detecting selection of the French flag icon and updating the control text value for Control8. Referring now to FIG. 5, a flowchart illustrating the update process is shown. On start-up 510, all interface text information appears in the system default language, for example, American English as shown in FIG. 2. Upon user selection of a control corresponding to a different language 520, a corresponding LRCF offset value is established 530. Next, the LRCF is referenced 540 and the language data associated with the block for the established LRCF offset value is obtained 550 and each interface control 560 is updated. Then, an updated user interface is rendered 570. Thus, all language-specific attributes of the interface are changed to comport with the language associated with the selected icon. A user may then select the icon corresponding to the default language or an icon corresponding to another available language, upon which selection all GUI text information will again change according to the foregoing update process.

A user may select an icon corresponding to a different language at any point in the operation of the machine and software application. Language updates occur without having to shut down the machine or restart the computer or software application. Furthermore, the update process can be repeated over and over again without interrupting machine, computer or software application performance. Thus, for example, referring to FIG. 2, a user may conveniently switch from initial American English to French and back to American English by selecting the French Flag icon 250, and then the American Flag icon 210 again, all without interrupting operation of the machine or application software. Upon selection of the French flag icon 250, a corresponding LRCF offset value (e.g., 500) is established 530. Next, the LRCF is referenced 540 and the language data associated with the block for the established LRCF offset value (i.e., LRCF offset value 500) is obtained 550 and each interface control 560 is updated. Then, an updated user interface is rendered 570 using the French language data. Upon subsequent selection of the the American flag icon 210, a corresponding LRCF offset value (e.g., 100) is established 530. Next, the LRCF is referenced 540 and the language data associated with the block for the established LRCF offset value (i.e., LRCF offset value 500) is obtained 550 and each interface control 560 is updated. Then, an updated user interface is rendered 570 using the American language data. Thus, each selection of a control corresponding to a different language will immediately result in a language update. Such interchangeability facilitates communication with foreign operators, training, and on-the-fly reconfiguration to efficiently accommodate a diverse group of operators.

As a structured table (e.g., the LRCF), database or the like defines all language-specific interface attributes, a non-programmer may edit them with relative ease using a low-level file editing procedure or applicable editing tools, such as a database update program. For example, a text file named “lrcf.ini” may include all language-specific interface attributes for a particular software application. An authorized Italian technician dissatisfied with certain control text may open Ircf.ini using a text editor and modify the control text as desired. Access to perform such modifications may be controlled using conventional security means.

A supported language can also easily be replaced with another language. In a preferred implementation, the user interface is configured to accommodate a finite number of language selection controls. For example, the interface shown in FIG. 2 provides six flag icons 210-260. The supported French language can be replaced with Greek by modifying the LRCF block for the French language data, which in the exemplary LRCF shown in FIG. 3 is block 5. The reference to the French flag icon graphic file (frflag.jpg) in line 500 would be replaced with a reference to a Greek flag graphic file (e.g., grflag.jpg). All French control text would be replaced with Greek equivalents. Other attributes, such as font parameters, would also be adjusted as may be necessary to ensure proper display of the Greek-specific text and controls.

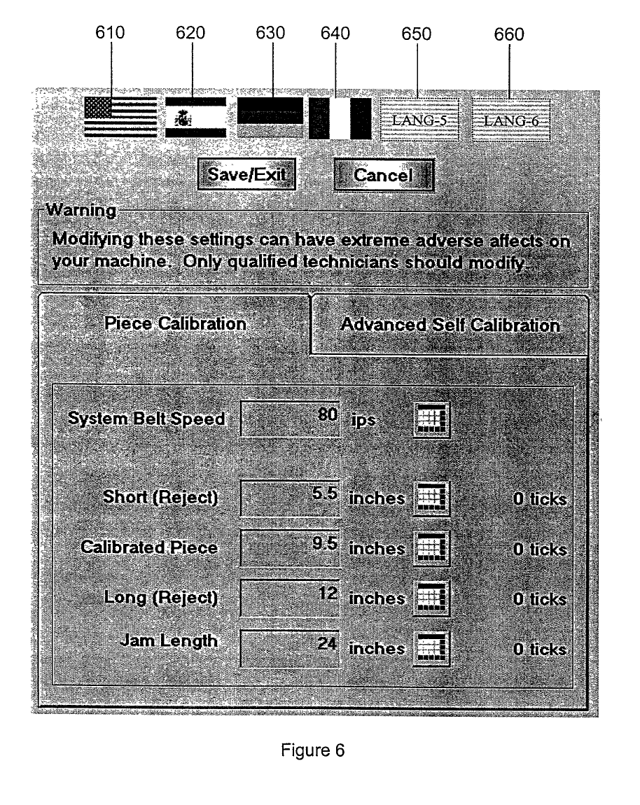

In another implementation, the user interface may be initially configured to accommodate several language selection controls, with some of the controls corresponding to languages established within the LRCF and the remaining controls provided for adding languages. For example, FIG. 6 shows a user interface capable of supporting at least six distinct languages, although only four languages are currently supported. The icons labeled “Lang-5” 650 and “Lang-6” 660, correspond to LRCF offsets for blocks 5 and 6, respectively. These corresponding LRCF blocks may be empty, hidden (i.e., not displayed) or include data for a default language, such as American English or other languages that may be freely chosen. In the latter case, selecting the icons labeled “Lang-5” 650 and “Lang-6” 660 would initiate the update process for the default American English language control data. By editing LRCF blocks 5 and 6, the icons labeled “Lang-5” 650 and “Lang-6” 660 can be reconfigured to call designated languages. Thus, for example, Greek and Portugese language support can be added by modifying LRCF blocks 5 and 6 accordingly. References to Greek and Portugese flag icon graphic files (e.g., grflag.jpg and poflag.jpg) may be included in LRCF lines 500 and 600, respectively, replacing any previous references to other icon graphic files (e.g., Lang5.jpg and Lang6.jpg). Control text would be included for Greek and Portugese equivalents, replacing any default control text. Other attributes, such as font parameters, would also be adjusted as may be necessary to ensure proper display of the Greek and Portugese-specific text and controls.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

Having thus described the present invention, what is claimed as new and desired to be secured by letters patent is as follows:

1. A computer implemented system for displaying language-specific attributes of a user interface in a desired language, said system including
a reference source including data corresponding to the language-specific attributes for the desired language,
means for defining the language-specific attributes of the interface with said data from the reference source, and
means for generating the user interface, including the language-specific attributes of the interface defined with said data from the reference source, on a visual display.

2. The computer implemented system according to claim 1, further including an interface control means for selecting the desired language.

3. The computer implemented system according to claim 2, wherein the data include text characters comprising a message for each language-specific attribute of the user interface having text.

4. The computer implemented system according to claim 3, wherein the data further include style parameters for the text characters, said style parameters defining the appearance of said text characters on the visual display.

5. The computer implemented system according to claim 4, wherein the data further include a reference to a character code set that includes said text characters for the language-specific attributes of the user interface having text.

6. The computer implemented system according to claim 5, wherein the data corresponding to the language-specific attributes for the desired language comprise a block of data having an offset value identifier.

7. The computer implemented system according to claim 6, wherein the means for defining the language-specific attributes of the interface with said data from the reference source includes means for updating the language-specific attributes of the user interface with the data.

8. The computer implemented system according to claim 7, wherein the interface control means references the offset value identifier for the block of data.

9. The computer implemented system according to claim 8, wherein the data further include a reference to a graphic file for a control icon corresponding to the interface control means for selecting the desired language.

10. The computer implemented system according to claim 9, further including an audio data file corresponding to a spoken message in the desired language for the user interface.

11. A computer implemented system for changing language-specific attributes of a user interface from a first language to a second language, said system including
interface control means for selecting the second language,
a reference source including data corresponding to the language-specific interface attributes for the second language,
means for replacing language-specific interface attributes for the first language with language-specific interface attributes for the second language, and
means for generating the user interface, including the language-specific attributes for the second language, on a visual display.

12. The computer implemented system according to claim 11, wherein the data corresponding to the language-specific interface attributes for the second language include text characters comprising a message in said second language for each language-specific attribute of the user interface having text.

13. The computer implemented system according to claim 12, wherein the data corresponding to the language-specific interface attributes for the second language further include style parameters for the text characters, said style parameters defining the appearance of said text characters on the visual display.

14. The computer implemented system according to claim 13, wherein the data further include references to a character code set that includes the text characters for each of said language specific attributes having text for the second language.

15. The computer implemented system according to claim 14, wherein the data corresponding to the language-specific attributes for the second language comprise a block of data for the second language having a unique offset value identifier.

16. The computer implemented system according to claim 15, wherein the means for replacing language-specific interface attributes for the first language with language-specific interface attributes for the second language includes means for updating the language specific attributes of the interface with the data corresponding to the language-specific interface attributes for the second language.

17. The computer implemented system according to claim 16, wherein the interface control means for selecting the second language references the offset value identifier for the block of data for the second language.

18. The computer implemented system according to claim 17, wherein said reference source is in a text format readable by a computer system and said means for generating the user interface on a visual display is in a format executable by the computer system.

19. A computer implemented method for changing language-specific user interface attributes from a first language to a second language, said method including the steps of
obtaining data corresponding to the language-specific interface attributes for the second language from a reference source,
replacing language-specific user interface attributes for the first language with language-specific user interface attributes for the second language based upon said data, and
generating a user interface, including the language-specific attributes for the second language, on a visual display.

20. The computer implemented method according to claim 19, wherein the data corresponding to the language-specific attributes for the second language comprise a block of data having a unique offset value identifier in the reference source, said method further including the step of referencing the offset value identifier for said block of data.

21. The method according to claim 20, further including the step of generating the offset value identifier for the block of data by selecting a user interface icon corresponding to the second language.

22. The method according to claim 21, wherein the step of obtaining data corresponding to the language-specific interface attributes for the second language further includes obtaining text characters comprising a message in said second language for each language-specific interface attribute having text.

23. The method according to claim 22, wherein the step of obtaining data corresponding to the language-specific interface attributes for the second language further includes obtaining style parameters for said text characters, said style parameters defining the appearance of said text characters on the visual display.

24. The method according to claim 23, wherein the step of obtaining data corresponding to the language-specific interface attributes for the second language further includes obtaining a reference to a character code set that includes said text characters in said second language for each language-specific interface attribute having text.
